(19) United States
(12) Patent Application Publication
(10) Pub. No.: US 2013/0304433 A1
(43) Pub. Date: Nov. 14, 2013

(54) Ligand Identification Scoring

(71) Applicant: UNIVERSITY OF FLORIDA RESEARCH FOUNDATION, INC., Gainesville, FL (US)

(72) Inventors: Zheng Zheng, Gainesville, FL (US); Kenneth Malcolm Merz, Gainesville, FL (US)

(73) Assignee: UNIVERSITY OF FLORIDA RESEARCH FOUNDATION, INC., Gainesville, FL (US)

(21) Appl. No.: 13/789,916

(22) Filed: Mar. 8, 2013

Related U.S. Application Data
(60) Provisional application No. 61/645,400, filed on May 10, 2012.

(51) Int. Cl. G06F 19/12

(52) U.S. Cl. CPC G06F 19/12
USPC 703/2

(57) ABSTRACT

Disclosed are various embodiments for systems and methods for predicting ligand with high binding affinities for protein receptors, as reflected by the binding free energy of the protein-ligand complex. A set of ligands and protein receptors are analyzed. Based on empirically determined data, such as van der Waal forces, hydrogen bonding, metal chelation, and other properties known for certain ligands, the binding free energy for a particular protein-ligand complex may be predicted. In addition, results may be filtered by sampling a range of predicted binding affinities by changing the arrangement in which the ligand docks with the protein receptor.

### CROSS-REFERENCE TO AND PRIORITY CLAIM FROM RELATED APPLICATIONS

This application makes reference to and claims priority from U.S. Application Ser. No. 61/645,400 filed on May 10, 2012. Said application is hereby incorporated herein by reference in its entirety.

### STATEMENT REGARDING FEDERALLY SPONSORED RESEARCH OR DEVELOPMENT

This invention was made with government support under grant numbers GM044974 and GM066859 awarded by the National Institute of Health. The government has certain rights in the invention.

### BACKGROUND

In pharmaceutical research, virtual screening of compound libraries is of great interest in order to find good drug candidates according to their binding ability to protein targets. A common strategy is to dock compounds into the protein binding site and evaluate the binding affinity using a suitable scoring function. A good candidate for a drug molecule should have an appropriate binding affinity for its target receptor, which is typically in the low nanomolar range. As the chemical space of interest to medicinal chemists covers a wide range of binding affinities, being able to accurately predict the binding affinity for these molecules is a central problem of drug design and remains a very significant challenge.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of one embodiment of at least one computing device according to various embodiments of the present disclosure.

FIG. 2 is a flowchart illustrating one example of functionality implemented as portions of the ligand analysis application executed in a computing device illustrated in FIG. 1 according to various embodiments of the present disclosure.

FIG. 3 is a schematic block diagram that provides one example illustration of a computing device of FIG. 1 according to various embodiments of the present disclosure.

### DETAILED DESCRIPTION

In the following discussion, a general description of the system and its components is provided, followed by a discussion of the operation of the same. Embodiments of the disclosure are directed to systems and methods employing new scoring algorithms that estimate the binding affinity of a protein-ligand complex, such as a ligand binding to a protein receptor, given a three-dimensional ligand structure.

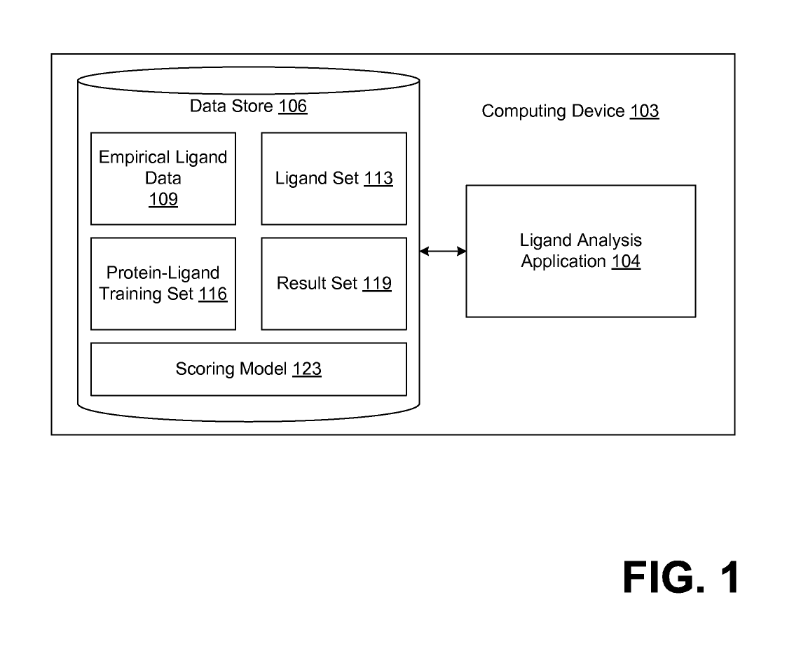

With reference to FIG. 1, shown is at least one computing device 103 according to various embodiments. The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

A ligand analysis application 104 may be executed in the computing device 103. In addition, other applications or additional functionality may be executed in the computing device 103 according to various embodiments of the present disclosure.

Also, various data is stored in a data store 106 that is accessible to the computing device 103. The data store 106 may be representative of a plurality of data stores as can be appreciated. The data stored in the data store 106 includes empirical ligand data 109, a ligand set 113, a protein-ligand training set 116, a result set 119, a scoring model 123 and potentially other data.

Empirical ligand data 109 includes a number of empirical terms, parameters, or similar data points that describe atoms or molecules comprising particular ligands or proteins. Such empirical terms are generally obtained as the result of previous experimentation. The empirical terms may comprise van der Waals (VDW) contacts, hydrogen bonding, desolvation effects, metal chelation, hydrophobicity and molecular weight for individual ligands, proteins, or protein receptors.

The ligand set 113 comprises the set of ligands which are to be analyzed by the ligand analysis application 104 to determine if one or more ligands have an acceptable binding affinity to a particular protein or receptor.

The protein-ligand training set 116 comprises a set of previously measured binding affinities and/or binding free energy values for a set of ligands and protein receptors of various protein-ligand complexes. The protein-ligand training set 116 is used to calibrate or train the ligand analysis application 104. Changes to the protein-ligand training set 116 can be made in order to recalibrate or retrain the ligand analysis application 104 to obtain different or more accurate results.

The result set 119 comprises the set of ligands generated by the application of a scoring model 123 to the ligand set 113 by the ligand analysis application 104. The result set 119, according to various embodiments of the present disclosure, may represent those ligands that have a binding affinity meeting a predefined threshold.

The scoring model 123 comprises a set of rules and equations used to predict the free binding energy or binding affinity of a ligand to a protein receptor or binding site. It is understood that a number of scoring models 123 may be included within the data store 106, each with its own advantages as will be described further herein. Scoring models 123 may be empirically based, physics based, statistically based, or a combination thereof according to various embodiments of the present disclosure.

In one embodiment of the present disclosure, the scoring model 123 may comprise an approach referred to herein as the Ligand Identification Scoring Algorithm (LISA). LISA uses empirical terms including van der Waals contacts, hydrogen bonding, desolvation effects, and metal chelation to describe the binding free energy of a protein-ligand complex. Among protein-ligand complexes with high binding affinity, metal chelation between active-site zinc ions and metal-binding “warheads” (e.g. carboxylate, sulfonamides, etc.) in ligands is widely observed; hence LISA also includes a zinc chelation term in some embodiments of the present disclosure to capture this class of interactions.

Van der Waals interactions are significant in protein-ligand complexes. The computed potential energy is determined by the distance between pairs of atoms. The Lennard-Jones 6-12 term is applied in LISA to represent van der Waals interactions when two atoms approach each other in a protein-ligand binding process. This interaction is represented by Equations 1 and 2:

$$\begin{matrix}Δ {G}_{AB}^{vdw} = {ɛ}_{AB} {\sum }_{i ∈ A} {\sum }_{j ∈ B} {f}_{ij} ( x , y , z ) & ( 1 ) \\ {f}_{ij} ( x , y , z ) = {( \frac{{σ}_{ij}}{{r}_{ij}} )}^{12} - {( \frac{{σ}_{ij}}{{r}_{ij}} )}^{6} & ( 2 )\end{matrix}$$

where rᵢⱼ is the distance between atom i in the protein and atom j in the ligand, σᵢⱼ is the interatomic separation at which repulsive and attractive forces balance (the sum of the van der Waals radii of atom i and atom j). ε is the potential well depth, subscripts A and B refers to atom type A and B.

Hydrogen bonding is also a very significant interaction found in most protein-ligand complexes. There are three principle variables associated with hydrogen bonding: the distance between the hydrogen bond donor and hydrogen bond acceptor, d_{HA}; the bond angle between the hydrogen bond donor and acceptor, θ_{D-H-A};and the H-A-AA angle defined by the hydrogen bond acceptor, σ_{H-A-AA}.

In LISA, hydrogen bonding is modeled in Equation 3 below. The optimal values for d_{HA} are derived from fitting LISA to the protein-ligand training set 116. The optimal value for σ_{D-H-A} is 180°. For carbonyl, carboxyl, and sulfonic oxygen atoms, the optimal value of σ_{H-A-AA} is 135°. For hydroxyl oxygen atoms, the optimal value for σ_{H-A-AA} is 109.5°. The hydrogen bonding interaction will be destabilized by any deviation of d_{HA}, θ_{D-H-A} and σ_{H-A-AA} from these optimal values.

$${M}_{h - bond} = {f}_{1} ( {d}_{HA} ) {f}_{2} ( {θ}_{D - H … A} ) {f}_{3} ( {σ}_{H … A - AA} ) \\ {f}_{1} ( {d}_{HA} ) = ɛ [ {( \frac{{r}_{0}}{{r}_{ij}} )}^{12} - 2 {( \frac{{r}_{0}}{{r}_{ij}} )}^{6} ] \\ {f}_{2} ( {θ}_{D - H … A} ) = {cos}^{2} ( {θ}_{D - H … A} - {θ}_{0} ) \\ {f}_{3} ( {σ}_{H … A - AA} ) = {cos}^{2} ( {σ}_{H … A - AA} - {σ}_{0} ) \qquad ( 3 )$$

Desolvation causes changes in the entropy as well as in enthalpy of the ligand and its target protein. This effect can be difficult to accurately characterize since it involves complicated ligand-water, protein-water, and water-water interactions before and after binding. Different algorithms have been used in other empirical scoring functions. In LISA, the free energy change caused by the desolvation effect is associated with the binding surface area. Other solutions regarding the computation of molecular surfaces are computationally expensive when evaluating thousands of protein-ligand complexes. To solve this issue, some embodiments of the disclosure reflect the binding surface area with a grid-based algorithm.

First, the effective distance between the ligand and its target protein, within which the desolvation effect occurs, is set to 5 Å. An atom from the ligand would be judged to be “within the binding surface” if any atom from the target protein is less than 5 Å from it. Second, the ligand analysis application 104 defines a box to cover the atoms from both the ligand and target protein marked as “within the binding surface” and creates regularly spaced grids within the box. The grid spacing used is 0.5 Å. Distances between the grids and every single atom in the box are computed. If a distance between a grid and atom is less than the van der Waals (VDW) radius of the atom, the grid is marked as “within the atom”, otherwise, the grid is marked as “outside the atom”. Third grid points marked as “within the atom” are translated by 0.5 Å along the Cartesian axes and if a grid point is reidentified as “outside the atom” after one of these translations, the grid point is labeled as a “boundary atom” of either the ligand or the protein. Because the grid points are closely spaced, the sum of the grid points marked as “boundary atoms” is identified as qualitatively reflecting the binding surface area of either the ligand or protein. Hence, the mean value of the sum of boundary atom grid points, of both the ligand and protein, represents the binding surface area, as represented in the equation:

$${M}_{desolvation} = \frac{{SASA}_{protein} + {SASA}_{ligand}}{2} \qquad ( 4 )$$

Metal chelates are observed in numerous metalloprotein-ligand complexes as metal binding “warheads.” A considerable number of chelates between ligands and metals such as Copper, Iron, or Magnesium can be found for protein-ligand complexes. However, these metal binding warheads do not affect the binding affinity significantly as compared to Zinc. The warheads that the ligands use to chelate the Zinc ion are usually Oxygen, Nitrogen and Sulfur. The binding energy is likely to reach its maximum when the distance between the ligand Nitrogen atom and Zinc is around 2 Å, and decreases either direction away from 2 Å. The influence of ligands' hydrophilicity or molecular weight factors on binding affinity has no clear relation with the presence of Zinc. Therefore the chelation term is modeled as:

M_{chelation}=(r_{N—Zn}−δ_{N—Zn})² (5)

where r is the distance between the binding atom in the ligand and Zn, and δ is the distance at which the chelation affinity is at its maximum.

In light of the above, mathematical model of LISA comprises of 18 terms including 14 van der Waals interaction terms, 2 hydrogen bonding terms, 1 desolvation term, and 1 metal chelation term expressed in form of:

$${pK}_{d} = {c}_{1} {M}_{VDW C 3 - C 3} + {c}_{2} {M}_{VDW C 3 - C 2 / Car} + {c}_{3} {M}_{VDW C 3 - N 3 / Npl 3} + {c}_{4} {M}_{VDW C 3 - N 4} + {c}_{5} {M}_{VDW C 3 / C 2 / Car - S} + {c}_{6} {M}_{VDW C 2 - C 2} + {c}_{7} {M}_{VDW C 2 - O 3} + {c}_{8} {M}_{VDW C 2 - O 2} + {c}_{9} {M}_{VDW C 2 - Npl 3} + {c}_{10} {M}_{VDW Car - Car} + {c}_{11} {M}_{VDW Car - O 2} + {c}_{12} {M}_{VDW Car - N 3} + {c}_{13} {M}_{VDW Car - N 2} + {c}_{14} {M}_{VDW O—N} + {c}_{15} {M}_{ HB O—O } + {c}_{16} {M}_{ HB O—N} \qquad ( 6 )$$

The values for each term in the LISA model may be derived from a training set of ligands. For the second, third, and fifth terms, each represents a combination of multiple interaction types sharing a common weight in order to decrease the number parameters to be fitted. Merging these interactions in this way is sensible because they represent similar interacting atom types.

Alternatively, the scoring model 123 may comprise a variant of the Ligand Identification Scoring Algorithm that incorporates additional parameters, referred to herein as LISA+. LISA+ classifies systems into one of four categories based on a ligand's hydrophobicity and molecular weight, and scores using an empirical function corresponding to each category.

Experimental results indicate that LISA has relatively poor predictive ability in ranking ligands within a low affinity (pK_{d}/pKᵢ<5) region, as well as within a high affinity (pK_{d}/pKᵢ>=8) region. The carbon atom number fraction (heavy atom fraction) of ligands and the ligand molecular weight both increase generally from the low affinity to the high affinity region, suggesting that ligand size and polarity are potential factors in the accuracy of the scoring model 123.

In order to improve the predictive ability of LISA, LISA+ categorizes ligands based on their size and polarity and different parameter sets are applied to evaluate the binding affinity. In LISA+, the ligand analysis application 104 first categorizes ligands into different groups based on the molecular weight and the ratio of carbon atoms in the entire ligand before any scoring. The categories fall into four groups (Table 1).

TABLE 1
Four ligand groups in LISA+ corresponding to ligand's
carbon number fraction and molecular weight.

| | carbon ratio <=0.65 | carbon ratio >0.65 |
|---|---|---|
| molecular | Hydrophilic and | Hydrophobic and |
| weight <=350 | small ligand | small ligand |
| molecular | Hydrophilic and | Hydrophobic and |
| weight >350 | large ligand | large ligand |

A different set of scoring parameters is applied to each group. The set of scoring parameters applied are provided below (Table 1A).

TABLE 1A
Parameters derived from linear fitting for
four different sets of scoring functions

| | | |
|---|---|---|
| Interaction Type | Weight | 95% Confidence Interval |

Low carbon ratio and low molecular weight

| | | | |
|---|---|---|---|
| sp3 C sp2 C | 0.2365 | 0.0207 | 0.4524 |
| sp3 C sp2 O | 0.2056 | 0.0706 | 0.3405 |
| sp3 C sp3 N | 0.4360 | 0.0189 | 0.8531 |
| sp3 C sp3 N | −0.1343 | −0.2497 | −0.0189 |
| sp3 C N cation | 3.4010 | 1.1635 | 5.6385 |
| sp3 C S | 1.2208 | 0.3358 | 2.1057 |
| sp2 C sp2 C | 0.1228 | 0.0132 | 0.2325 |
| sp2 C sp3 O | 0.0941 | 0.0025 | 0.1857 |
| sp2 C sp2 O | 0.3247 | 0.0322 | 0.6172 |
| sp2 C N cation | −1.5279 | −2.5542 | −0.5016 |
| HB O H . . . N | 1.9492 | 0.0662 | 3.8322 |
| HB N H . . . O | 1.1315 | 0.3392 | 1.9239 |
| Surface area | −0.0449 | −0.0628 | −0.0271 |

Low carbon ration, high molecular weight

| | | | |
|---|---|---|---|
| sp3 C sp2 C | 0.2460 | 0.0374 | 0.4546 |
| sp3 C sp3 O | 0.0989 | 0.0022 | 0.1955 |
| sp3 C sp2 O | 0.1223 | 0.0012 | 0.2433 |
| sp3 C sp2 N | −0.2992 | −0.5439 | −0.0144 |
| sp3 C N cation | 3.7510 | 1.1302 | 6.3719 |
| sp3 C S | 0.5418 | 0.0459 | 1.0376 |
| sp2 C sp2 O | 0.3239 | 0.0010 | 0.6468 |
| sp2 C sp3 N | 0.1276 | 0.0420 | 0.2131 |
| sp2 C sp2 N | 0.4712 | 0.0206 | 0.9218 |
| sp2 C N cation | −0.9372 | −1.8463 | −0.0280 |
| HB O H . . . O | 0.9482 | 0.1412 | 1.7552 |
| HB O H . . . N | 0.8587 | 0.0217 | 1.6957 |
| HB N H . . . O | 2.6710 | 1.9054 | 3.4365 |
| Surface area | −0.0229 | −0.0355 | −0.0103 |

High carbon ration, low molecular weight

| | | | |
|---|---|---|---|
| sp3 C sp3 C | 0.3559 | 0.1568 | 0.5551 |
| sp3 C sp2 C | 0.2168 | 0.1056 | 0.3280 |
| sp3 C sp3 O | −0.1627 | −0.0129 | −0.3125 |
| sp3 C sp2 N | 0.2194 | 0.0233 | 0.4155 |
| sp3 C N cation | 1.6176 | 0.1159 | 3.1193 |
| sp3 C S | 1.7532 | 0.9358 | 2.5707 |
| sp2 C sp2 C | 0.0859 | 0.0054 | 0.1664 |
| sp2 C sp3 O | 0.2253 | 0.0137 | 0.4370 |
| sp2 C sp3 N | 0.2278 | 0.0097 | 0.4459 |
| sp2 C N cation | −1.6420 | −2.7613 | −0.5228 |
| sp2 C S | 1.2274 | 0.4191 | 2.0357 |
| HB O H . . . O | 1.3705 | 0.3657 | 2.3753 |
| HB N H . . . O | 1.1544 | 0.0241 | 2.2847 |
| Surface Area | −0.0469 | −0.0561 | −0.0377 |

High carbon ration, high molecular weight

| | | | |
|---|---|---|---|
| sp3 C sp3 C | 0.1701 | 0.0334 | 0.3067 |
| sp3 C sp2 C | 0.0803 | 0.0012 | 0.1593 |
| sp3 C sp3 O | −0.1218 | −0.2328 | −.0.108 |
| sp3 C sp3 N | 0.3575 | 0.0988 | 0.6162 |
| sp3 C S | 1.1676 | 0.7129 | 1.6223 |
| sp2 C sp2 C | 0.1480 | 0.0061 | 0.2899 |
| sp2 C sp3 O | 0.6735 | 0.3280 | 1.0190 |
| sp2 C sp2 O | 0.0842 | 0.0011 | 0.1673 |
| sp2 C sp3 N | 0.1699 | 0.0061 | 0.3337 |
| sp2 C N cation | −0.8892 | −1.7745 | −0.0038 |
| sp2 C S | 0.6735 | 0.0036 | 1.3433 |
| HB O H . . . O | 0.6379 | 0.0365 | 1.2393 |
| HB O H . . . N | 3.9650 | 0.7266 | 7.2033 |
| HB N H . . . O | 0.6306 | 0.0688 | 1.1925 |
| Surface Area | −0.0371 | −0.0440 | −0.0302 |

The interaction weights are given along with the lower and upper bounds of the 95% confidence interval.

In another embodiment of the present disclosure, the scoring model 123 may comprise a physics-based approach referred to herein as the Knowledge-based & Empirical Combined Scoring Algorithm (KECSA).

Empirical scoring functions are computationally efficient, because of their simple energy functions, but this also highlights their major limitation—training-set dependent parameterization. KECSA introduces a knowledge-based mean force to generate the parameters for the Lennard-Jones potential terms. The concept of knowledge-based scoring comes from the potential of mean force, which states that the systematic average force is related to radial distribution function of particles. Knowledge-based scoring functions are normally parameterized using protein-ligand complexes structural information including atomic pairwise distance distributions. This is an advantage compared with empirical scoring functions, the parameters of which are usually obtained by fitting to binding free energy data.

The concept of the potential of mean force can be illustrated by a simple fluid system of N particles whose positions are r₁ . . . r_{N}. The average potential ω⁽ⁿ⁾(r₁ . . . r_{N}) is expressed as:

$${ω}^{( n )} ( {r}_{1} … {r}_{n} ) = - \frac{1}{β} ln ( {g}^{( n )} ( {r}_{1} … {r}_{n} ) ) \qquad ( 7 )$$

where g⁽ⁿ⁾ is called a correlation function and β=1/k_{B}T and k_{B} is the Boltzmann constant and T is the system temperature.

Hence the mean potential of the system with N particles is strictly the potential that gives the average force over all the configurations of the n+1 . . . N particles acting on a particle at any fixed configuration keeping the 1 . . . n particles fixed. The mean potential can be described as follows:

$$- {∇}_{j} {ω}^{( n )} = \frac{\int … \int {e}^{- β U} ( {∇}_{j} U ) d {r}_{n + 1} … d {r}_{N}}{\int … \int {e}^{- β U} d {r}_{n + 1} … d {r}_{N}} , \\ j = 1 , 2 , … , n \qquad ( 8 )$$

where U is the total potential energy of the system.

The average potential is expressed as Equation 9 for the special case of a system with an observed particle number of n=2, as is the case for pairwise atoms from the protein and ligand.

$${ω}_{ij}^{( 2 )} ( {r}_{12} ) = - \frac{1}{β} ln ( {g}^{( 2 )} ( {r}_{12} ) ) = - \frac{1}{β} ln ( \frac{{ρ}_{ij} ( {r}_{12} )}{{ρ}_{ij}^{*} ( {r}_{12} )} ) \qquad ( 9 )$$

Where g⁽²⁾(r) is the pair distribution function, ρᵢⱼ(r) is the number density for the atom pairs of types i and j observed in the known protein structures and ρ*ᵢⱼ(r) is the number density of the corresponding pair in a reference state. In order to obtain the pure interaction between atoms, a reference state is required to remove the contribution of the non-interacting state potential. So, in the reference state, the system of particles is like an ideal-gas state defined by fundamental statistical mechanics, in which particles would be evenly distributed in the binding site. Equation 9 can also be expressed as:

$${ω}_{ij}^{( 2 )} ( {r}_{12} ) = - \frac{1}{β} ln ( {g}^{( 2 )} ( {r}_{12} ) ) = - \frac{1}{β} ln ( \frac{{n}_{ij} ( {r}_{12} )}{{n}_{ij}^{*} ( {r}_{12} )} ) \qquad ( 10 )$$

where nᵢⱼ(r) and n*ᵢⱼ(r) are numbers of atom pairs of type i and j, respectively, at distance r for the observed structures and the reference state.

In potential of mean force methods, the number of the corresponding pairs in the reference state cannot be exactly obtained for protein-ligand systems due to the effects of connectivity, excluded volume, composition, etc. Therefore, the pairwise interaction potential cannot be accurately calculated. Nonetheless, this idea of potential of mean force scoring has advantages over empirical scoring, because it directly relates pairwise interaction to structural data instead of fitting to known binding affinity data. Additionally, the potential of mean force is more efficient than force field scoring due to the avoidance of higher expense computations. A new concept of the reference state is introduced, in order to relate the mean-force potential to Lennard-Jones potential. Hence the atomic pairwise interaction model can be parameterized exclusively from structural data instead of binding data or quantum calculations.

The potential of mean force and the Lennard-Jones potential for each pairwise interaction should be equated. However, the Lennard-Jones potential reflects pure interactions between two types of atoms, while a knowledge-based potential is an averaged potential contributed by all atoms within the binding region. In this case, when trying to equate the mean force potential to an empirical potential, all other interactions contributed to the pairwise atomic distributions should be removed and only the observed pairwise interaction in the binding region should be kept by defining a new reference state.

In order to do that, within this new reference state (termed reference state II), a system of particles is under a mean force contributed by all atoms in the binding region excluding the interaction force between the observed atom pairs i and j. In other words, for reference state II, interactions between observed atom pairs i and j are removed while the interactions between atom i and all atoms except j are retained (and likewise for interactions between j and non i atoms). Just like in the classical reference state, the number of corresponding pairs in reference state II cannot be exactly calculated for protein-ligand systems.

When equated with the Lennard-Jones potential, the mean force can be expressed as:

$$\begin{matrix}{E}_{ij} ( r ) = - RT ln [ \frac{{n}_{ij} ( r )}{{n}_{ij}^{**} ( r )} ] \\ = RT ( ln [ {n}_{ij}^{**} ( r ) ] - ln [ {n}_{ij} ( r ) ] ) \\ = \frac{- 1}{{( \frac{β}{α} )}^{\frac{α}{α - β}} - {( \frac{β}{α} )}^{\frac{β}{α - β}}} ɛ [ {( \frac{σ}{{r}_{ij}} )}^{α} - {( \frac{σ}{{r}_{ij}} )}^{β} ]\end{matrix} \qquad ( 11 )$$

where σ is the distance at which the inter-particle potential is zero and ε is the well depth. The exponents for the repulsive term and attractive term are α and β, respectively. The exponents assigned to the fixed 12-6 exponent values are derived because the repulsion and attraction forces change with different types of pairwise interaction and Eᵢⱼ(r) in Equation 11 includes both van der Waals potential and electrostatic potential. This means the Lennard-Jones potential on the right hand side of the equation above has two components:

$$\frac{- 1}{{( \frac{β}{α} )}^{\frac{α}{α - β}} - {( \frac{β}{α} )}^{\frac{β}{α - β}}} ɛ [ {( \frac{σ}{{r}_{ij}} )}^{α} - {( \frac{σ}{{r}_{ij}} )}^{β} ] \approx 4 {ɛ}_{0} [ {( \frac{{σ}_{0}}{{r}_{ij}} )}^{12} - {( \frac{{σ}_{0}}{{r}_{ij}} )}^{6} ] + \frac{{q}_{1} {q}_{2}}{{ɛ}_{1} {r}_{ij}} \qquad ( 12 )$$

The reason to use the Lennard-Jones formula on the left hand side of Equation 12 instead of partitioning them into van der Waals and electrostatic potentials is that the Lennard-Jones potential reaches 0 at σ and R, while reaching its minimum value when r is

$${( \frac{α}{β} )}^{\frac{1}{α - β}} .$$

Based on these properties, equations can be built in order to derive the unknown parameters.

In Equation 11, n**ᵢⱼ(r) and nᵢⱼ(r) are the number of protein-ligand atom pairwise interactions within a defined contact distance, whose volume is 4πr^{a}Δr both in the reference state II and in the training set. A to-be-determined parameter a for the shell volume is introduced because of the inaccessible volume present in protein-ligand systems, and because of the deviation of nᵢⱼ(r) in the training set from the “perfect” pairwise number under mean force. So parameter a will adopt values other than 2.

For reference state II, interactions between the observed atom pairs are eliminated while interactions between observed atoms and other atoms are preserved. In this case, the number distribution is strongly related to the ratio of the observed atom pair number to the total number of atom pairs. If the fraction of the observed atoms is very large, the system would be similar to the non-interacting ideal gas case, because most of the pairwise atomic interactions are eliminated by definition. On the other hand, if this ratio is very small, the system would be more like the mean force state, because most of the pairwise atomic interactions are preserved as the original system. Hence, the number distribution for two extreme situations in reference state II can be modeled as:

$$\begin{matrix}{n}_{ij}^{**} ( r ) = ( \frac{{N}_{ij}}{V} 4 π {r}^{a} Δ r ) , {N}_{ij} \to N & ( 12 ) \\ {n}_{ij}^{**} ( r ) = {n}_{ij} ( r ) , {N}_{ij} \to 0 & ( 13 )\end{matrix}$$

where Nᵢⱼ is the total number of protein-ligand pairwise interactions between atom i and j within the distance bin (r, r+Δr) and N is the total number of atom pairwise interactions in the training set. V is the volume of the averaged binding site, which is given as

$$\frac{4}{a + 1} π {R}^{a + 1} .$$

For any case within these two extreme situations, number distribution for reference state II is defined as

$${n}_{ij}^{**} ( r ) = ( \frac{{N}_{ij}}{V} 4 π {r}^{a} Δ r ) \frac{{N}_{ij}}{N} + ( {n}_{ij} ( r ) ) ( 1 - \frac{{N}_{ij}}{N} ) \qquad ( 14 )$$

in order to satisfy that the integral from 0 to R (cutoff distance where the atomic interaction could be regarded as zero) is Nᵢⱼ.

On the right hand side of Equation 14, the term in the first bracket reflects the number of protein-ligand atom pairwise interactions within a contact distance r in an ideal gas state where the particles are evenly distributed in the binding pocket volume. The term in the second bracket reflects the contact number in the mean force state, i.e., the observed contact numbers collected from a protein-ligand structural database.

Hence, combining Equations 11 and 14 provides:

$$ln [ ( \frac{{N}_{ij}}{V} 4 π {r}^{a} Δ r ) \frac{{N}_{ij}}{N} + ( {n}_{ij} ( r ) ) ( 1 - \frac{{N}_{ij}}{N} ) ] - ln [ {n}_{ij} ( r ) ] = \frac{- 1}{{( \frac{β}{α} )}^{\frac{α}{α - β}} - {( \frac{β}{α} )}^{\frac{β}{α - β}}} \frac{ɛ}{RT} [ {( \frac{σ}{{r}_{ij}} )}^{α} - {( \frac{σ}{{r}_{ij}} )}^{β} ] \qquad ( 15 )$$

The Lennard-Jones potential reaches 0 at σ and R, thus providing:

$$\begin{matrix}ln [ \frac{{N}_{ij}}{N} ( \frac{{N}_{ij} ( a + 1 ) {σ}^{a} Δ r}{{R}^{a + 1} {n}_{ij} ( σ )} ) + ( 1 - \frac{{N}_{ij}}{N} ) ] = 0 , and & ( 16 ) \\ ln [ \frac{{N}_{ij}}{N} ( \frac{{N}_{ij} ( a + 1 ) {R}^{a} Δ r}{{R}^{a + 1} {n}_{ij} ( R )} ) + ( 1 - \frac{{N}_{ij}}{N} ) ] = 0. & ( 17 )\end{matrix}$$

while the Lennard-Jones potential reaches its minimum value when r is

$${( \frac{α}{β} )}^{\frac{1}{α - β}} .$$

To simplify the expressions the factor

$${( \frac{α}{β} )}^{\frac{1}{α - β}}$$

is assigned as η.

$$\frac{\begin{matrix}a \frac{{N}_{ij}}{N} ( \frac{{N}_{ij} ( a + 1 ) {( η σ )}^{a - 1} Δ r}{{R}^{a + 1} {n}_{ij} ( ησ )} ) - \\ \frac{{N}_{ij}}{N } ( \frac{{N}_{ij} ( a + 1 ) {( η σ )}^{a - 1} Δ r}{{R}^{a + 1} {n}_{ij}^{2} ( ησ )} ) D ( {n}_{ij} ( n σ ) )\end{matrix}}{\frac{{N}_{ij}}{N} ( \frac{{N}_{ij} ( a + 1 ) {( η σ )}^{a} Δ r}{{R}^{a + 1} {n}_{ij} ( ησ )} ) + ( 1 - \frac{{N}_{ij}}{N} )} = 0 \qquad ( 18 )$$

Although the values of α and β are unknown, it is known that the value of η is unique for each combination of α and β. Table 2 below lists all η values for each whole number combination of α and β from 2-1 to 15-14. Different η values will be chosen for every pairwise interaction, to satisfy the well depth distance at ησ.

TABLE 2
Lennard-Jones potential models with their corresponding η values.

| | LJ | | LJ | | LJ | | LJ | | LJ | | LJ | | LJ |
|---|---|---|---|---|---|---|---|---|---|---|---|---|---|
| η | model | η | model | η | model | η | model | η | model | η | model | η | model |
| 1.0714 | 15-14 | — | — | — | — | — | — | — | — | — | — | — | — |
| 1.0742 | 15-13 | 1.0769 | 14-13 | — | — | — | — | — | — | — | — | — | — |
| 1.0772 | 15-12 | 1.0801 | 14-12 | 1.0833 | 13-12 | — | — | — | — | — | — | — | — |
| 1.0806 | 15-11 | 1.0837 | 14-11 | 1.0871 | 13-11 | 1.0909 | 12-11 | — | — | — | — | — | — |
| 1.0845 | 15-10 | 1.0878 | 14-10 | 1.0914 | 13-10 | 1.0954 | 12-10 | 1.1000 | 11-10 | — | — | — | — |
| 1.0889 | 15-9 | 1.0924 | 14-9 | 1.0963 | 13-9 | 1.1006 | 12-9 | 1.1055 | 11-9 | 1.1111 | 10-9 | — | — |
| 1.0940 | 15-8 | 1.0978 | 14-8 | 1.1020 | 13-8 | 1.1067 | 12-8 | 1.1120 | 11-8 | 1.1180 | 10-8 | 1.1250 | 9-8 |
| 1.1000 | 15-7 | 1.1041 | 14-7 | 1.1087 | 13-7 | 1.1138 | 12-7 | 1.1196 | 11-7 | 1.1262 | 10-7 | 1.1339 | 9-7 |
| 1.1072 | 15-6 | 1.1117 | 14-6 | 1.1168 | 13-6 | 1.1225 | 12-6 | 1.1289 | 11-6 | 1.1362 | 10-6 | 1.1447 | 9-6 |
| 1.1161 | 15-5 | 1.1212 | 14-5 | 1.1269 | 13-5 | 1.1332 | 12-5 | 1.1404 | 11-5 | 1.1487 | 10-5 | 1.1583 | 9-5 |
| 1.1277 | 15-4 | 1.1335 | 14-4 | 1.1399 | 13-4 | 1.1472 | 12-4 | 1.1555 | 11-4 | 1.1650 | 10-4 | 1.1761 | 9-4 |
| 1.1435 | 15-3 | 1.1503 | 14-3 | 1.1579 | 13-3 | 1.1665 | 12-3 | 1.1763 | 11-3 | 1.1877 | 10-3 | 1.2009 | 9-3 |
| 1.1676 | 15-2 | 1.1760 | 14-2 | 1.1855 | 13-2 | 1.1962 | 12-2 | 1.2085 | 11-2 | 1.2228 | 10-2 | 1.2397 | 9-2 |
| 1.2134 | 15-1 | 1.2251 | 14-1 | 1.2383 | 13-1 | 1.2535 | 12-1 | 1.2710 | 11-1 | 1.2915 | 10-1 | 1.3161 | 9-1 |
| — | — | — | — | — | — | — | — | — | — | — | — | — | — |
| — | — | — | — | — | — | — | — | — | — | — | — | — | — |
| — | — | — | — | — | — | — | — | — | — | — | — | — | — |
| — | — | — | — | — | — | — | — | — | — | — | — | — | — |
| — | — | — | — | — | — | — | — | — | — | — | — | — | — |
| — | — | — | — | — | — | — | — | — | — | — | — | — | — |
| — | — | — | — | — | — | — | — | — | — | — | — | — | — |
| 1.1429 | 8-7 | — | — | — | — | — | — | — | — | — | — | — | — |
| 1.1547 | 8-6 | 1.1667 | 7-6 | — | — | — | — | — | — | — | — | — | — |
| 1.1696 | 8-5 | 1.1832 | 7-5 | 1.2000 | 6-5 | — | — | — | — | — | — | — | — |
| 1.1892 | 8-4 | 1.2051 | 7-4 | 1.2247 | 6-4 | 1.2500 | 5-4 | — | — | — | — | — | — |
| 1.2167 | 8-3 | 1.2359 | 7-3 | 1.2599 | 6-3 | 1.2910 | 5-3 | 1.3333 | 4-3 | — | — | — | — |
| 1.2599 | 8-2 | 1.2847 | 7-2 | 1.3161 | 6-2 | 1.3572 | 5-2 | 1.4142 | 4-2 | 1.5000 | 3-2 | — | — |
| 1.3459 | 8-1 | 1.3831 | 7-1 | 1.4310 | 6-1 | 1.4953 | 5-1 | 1.5874 | 4-1 | 1.7321 | 3-1 | 2.0000 | 2-1 |

In order to find a, σ and η values with the three equations listed above, the cutoff distance, represented as R, must still be determined. A nonlinear programming should be used to find a reasonable R for each pairwise interaction type instead of assigning a fixed R value. Ideally, R should be as large as possible since the Lennard-Jones potential approaches 0 when the distance approaches infinity. Meanwhile, for any r between σ and R, the potential value is below 0. Here we build an inequality constraint for our nonlinear programming (Eqn.14).

$$ln [ \frac{{N}_{ij}}{N} ( \frac{{N}_{ij} • ( a + 1 ) • {r}^{a} •Δ r}{{R}^{a + 1} {n}_{ij} ( R )} ) + ( 1 - \frac{{N}_{ij}}{N} ) ] < 0 , σ < r < R \qquad ( 14 )$$

According to the goal of maximizing R, with three equality constraints (Equations 11-13) and an inequality constraint (Equation 14), a, σ and η can be derived. Any generated η would be compared with the η values in Table 2, in order to determine the closest α and β pair. Putting these values back in Equation 15 permits the calculation of all of the values for ε. During experimentation, all pairwise interactions among 18 atom types were examined and 49 significant interaction types were chosen, including 38 van der Waals and 11 hydrogen bonding interaction types. All parameters derived are listed in Table 3.

TABLE 3
Parameters for all 49 pairwise potential

| interaction | | | | | | | | | | |
|---|---|---|---|---|---|---|---|---|---|---|
| type | c2c2 | c2car | c2n2 | c2n3 | c2n4 | c2nam | c2nar | c2npl3 | c2o2 | c2o3 |
| σ | 4.145 | 3.630 | 3.450 | 3.285 | 3.215 | 3.505 | 3.575 | 3.505 | 3.370 | 3.135 |
| a | 3.375 | 2.224 | 3.085 | 2.810 | 3.089 | 4.296 | 2.662 | 2.273 | 3.298 | 2.992 |
| R | 5.900 | 6.535 | 4.755 | 4.220 | 4.235 | 4.265 | 5.390 | 6.485 | 4.430 | 5.345 |
| ε | 0.091 | 0.041 | 0.388 | 0.035 | 0.133 | 1.003 | 0.296 | 0.769 | 1.735 | 0.071 |
| LJ model | 12-5 | 11-1 | 10-9 | 12-8 | 14-12 | 15-6 | 12-11 | 15-14 | 12-11 | 13-4 |

| interaction | | | | | | | | | | |
|---|---|---|---|---|---|---|---|---|---|---|
| type | c2s | c3c2 | c3c3 | c3car | c3n2 | c3n3 | c3n4 | c3nam | c3nar | c3npl3 |
| σ | 4.350 | 3.940 | 4.290 | 3.850 | 3.580 | 3.650 | 4.570 | 4.470 | 3.455 | 3.815 |
| a | 2.505 | 3.049 | 2.759 | 2.237 | 2.404 | 1.759 | 2.988 | 3.581 | 2.990 | 2.347 |
| R | 6.425 | 6.210 | 6.840 | 6.775 | 6.130 | 6.945 | 6.850 | 6.165 | 5.435 | 6.160 |
| ε | 0.387 | 0.085 | 0.364 | 0.454 | 0.053 | 0.123 | 0.022 | 0.071 | 0.067 | 0.129 |
| LJ model | 12-11 | 14-3 | 5-4 | 5-3 | 15-9 | 13-12 | 12-7 | 12-7 | 12-9 | 4-3 |

| interaction | | | | | | | | | | |
|---|---|---|---|---|---|---|---|---|---|---|
| type | c3o2 | c3o3 | c3s | carcar | carn2 | carn3 | carn4 | carnam | carnar | carnpl3 |
| σ | 3.200 | 3.325 | 3.940 | 3.700 | 3.600 | 3.700 | 4.360 | 3.720 | 3.565 | 3.665 |
| a | 2.742 | 3.164 | 1.965 | 1.898 | 2.079 | 2.032 | 1.089 | 3.655 | 1.389 | 1.736 |
| R | 4.515 | 5.650 | 6.630 | 6.855 | 6.440 | 6.845 | 6.980 | 6.030 | 6.865 | 6.675 |
| ε | 0.343 | 0.038 | 0.016 | 0.249 | 0.013 | 0.005 | 0.056 | 0.279 | 0.206 | 0.016 |
| LJ model | 9-6 | 13-7 | 14-1 | 4-3 | 11-1 | 8-1 | 9-5 | 14-13 | 15-14 | 15-6 |

| interaction | | | | | | | | | | |
|---|---|---|---|---|---|---|---|---|---|---|
| type | caro2 | caro3 | cars | n2o2HB | n2o3HB | n3o2HB | n3o3HB | namo2HB | namo3HB | npl3o2HB |
| σ | 3.430 | 3.690 | 3.920 | 2.640 | 2.670 | 2.550 | 2.605 | 2.610 | 2.625 | 2.585 |
| a | 2.840 | 2.204 | 1.627 | 2.056 | 2.365 | 0.989 | 1.788 | 2.057 | 3.475 | 1.377 |
| R | 6.600 | 6.505 | 6.975 | 6.420 | 6.465 | 6.745 | 4.585 | 4.765 | 4.160 | 4.995 |
| ε | 0.120 | 0.030 | 0.050 | 0.062 | 0.036 | 0.196 | 0.217 | 1.700 | 0.172 | 0.219 |
| LJ model | 12-10 | 6-2 | 9-5 | 15-8 | 15-5 | 14-10 | 13-9 | 12-10 | 11-8 | 13-8 |

| interaction | | | | | | | | | |
|---|---|---|---|---|---|---|---|---|---|
| type | npl3o3HB | o2n2 | o2nam | o2nar | o2o2 | o3n2HB | o3o2HB | o3o2 | o3o3HB |
| σ | 2.635 | 2.570 | 4.125 | 3.380 | 3.065 | 2.510 | 2.445 | 3.365 | 2.080 |
| a | 1.899 | 2.397 | 2.784 | 2.292 | 2.767 | 1.345 | 1.998 | 3.250 | 2.408 |
| R | 6.755 | 6.845 | 6.065 | 6.070 | 6.055 | 4.395 | 6.065 | 6.480 | 6.990 |
| ε | 0.272 | 0.010 | 0.008 | 0.073 | 0.034 | 0.116 | 2.002 | 0.024 | 0.038 |
| LJ model | 15-12 | 7-1 | 13-3 | 11-7 | 4-1 | 15-8 | 14-13 | 3-2 | 11-3 |

With all of the enthalpy terms determined in the analytical manner described above, entropy terms should be decided upon in an empirical manner. Structural information such as the number of rotatable bonds, number of double and aromatic bonds, molecular mass, count of carbon/oxygen/nitrogen atoms, buried surface area, etc. should be collected from all ligands in the training set. The selection of entropy terms should be based on their contribution to the linear regression model used and the 95% confidence interval of which should not include 0. Commonly selected entropy terms often include: number of rotatable bonds in the ligand, the molecular mass of the ligand, number of aromatic bonds in the ligand, number of oxygen atoms in the ligand, number of nitrogen atoms in the ligand, the nonpolar buried surface area, total buried surface area, the ratio of the nonpolar buried surface and total ligand surface area and, finally, the ratio of the total buried surface area and the total ligand surface area.

Further, LISA, LISA+, and KECSA may be used in conjunction with a blurring technique to refine results in certain situations. The blurring technique generates a number of poses for each protein-ligand complex. Each ligand pose is derived from different combinations of the following three types of movements: bond rotation, whole-molecule rotation and translation. When the top poses of all ligand candidates are generated, LISA, LISA+ and KECSA are employed to rank the candidates by binding affinity.

The components executed on the computing device 103 for example, include a ligand analysis application 104, and other applications, services, processes, systems, and/or engines that may facilitate data retrieval, computation and/or communication for the different data models used by the ligand analysis application. It should be appreciated that the data store 106 may be provided in a first computing device and the ligand analysis application 104 executed in one or more other computing devices, where the ligand analysis application 104 and data store 112 are in communication via one or more networks. Such a network can include, for example, the Internet, intranets, extranets, wide area networks (WANs), local area networks (LANs), wired networks, wireless networks, or other suitable networks, etc., or any combination of two or more such networks.

Next, a general description of the operation of the various components of the computing device 103 is provided.

To begin, the ligand analysis application 104 calibrates or otherwise prepares one or more scoring models 123. To do so, the ligand analysis application 104 applies one or more protein-ligand training sets 116 to a scoring model 123. The values of the various terms or parameters used by the scoring model 123 are modified by the ligand analysis application 104 so that, for the set protein-ligand complexes in the training set 116, the scoring model 123 will predict the corresponding binding energies in the protein-ligand training set 116. Once the ligand analysis application 104 is able to accurately model the binding free energy for protein-ligand complexes in the protein ligand training set 116, the ligand analysis application 104 is ready to model free binding energies for a given ligand set 113.

The ligand analysis application 104 then receives a ligand set 113 for analysis using a predefined scoring model 123 trained by the protein ligand training set 116. According to the scoring model 123 used by the ligand analysis application 104, additional empirical ligand data 109 may be used in conjunction with the scoring model 123.

The ligand analysis application 104 then applies the scoring model 123 to each protein ligand complex in the ligand set 113. The result set 119 is then created storing the predicted free binding energy for each protein ligand complex and the ligand set 113. The result set 119 is subsequently stored by the ligand analysis application 104 in the data store 106.

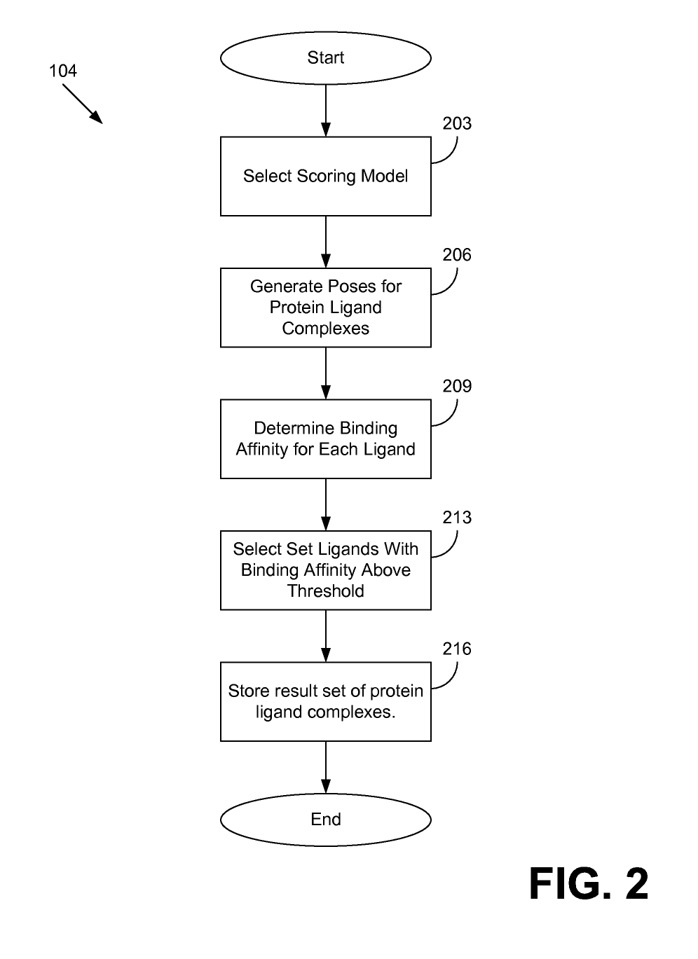

Referring next to FIG. 2, shown is a flowchart that provides one example of the operation of a portion of the ligand analysis application 104 according to various embodiments of the present disclosure. It is understood that the flowchart of FIG. 2 provides merely an example of the many different types of functional arrangements that may be employed to implement the operation of the portion of the ligand analysis application 104 as described herein. As an alternative, the flowchart of FIG. 2 may be viewed as depicting an example of steps of a method implemented in the computing device 103 (FIG. 1) according to one or more embodiments of the present disclosure. It is assumed that the ligand analysis application 104 has already received a ligand set 113 (FIG. 1) on which it will operate.

Beginning with Box 203 the ligand analysis application 104 selects a scoring model 123 (FIG. 1) from the data store 106. The data model 123 may be selected based upon a value passed by a call to the ligand analysis application 104. Alternatively the ligand analysis application 104 may choose a default scoring model 123.

Proceeding to box 206, the ligand analysis application 104 generates a number of poses for each protein-ligand complex. First the ligand analysis application 104 recognizes the starting position for the ligand candidates of the ligand set 113 by locating a pre-docked ligand in the binding pocket of a receptor. Ligand candidates in the ligand set 113 are then placed into the binding pocket and roughly coincided with the pre-docked ligand.

Next, the ligand analysis application 104 performs three-dimensional movements of the ligand candidates from the ligand set 113 within the binding pocket. The movements can be categorized into three steps: single bond rotation, whole molecular rotation and translational movement. Each step generates new poses until a new pose collapses with the binding pocket. The next movement step is performed based on poses generated from the previous movement step until collapsing with the binding pocket. After all possible poses are collected, the scoring function is applied to choose the best scored pose as a starting pose for next round of “blurring” movements. The program will end searching when the score for all poses generated from a new blurring round is smaller than 0.5 kcal/mol.

As part of the blurring technique, a greedy algorithm or a genetic algorithm may be used for pose searching. Use of the genetic algorithm often helps to avoid ligand poses that fall into a local minimum.

Preceding the box 209, the ligand analysis application 104 applies the scoring model 123 to each of the generated poses. The ligand analysis application then averages the predicted free binding energy for each pose of a protein ligand complex created from the ligand set 113 to generate the predicted free binding energy.

Referring next to box 213, the ligand analysis application 104 selects the set of protein ligand complexes with a binding affinity above a predetermined threshold. In some embodiments of the present disclosure, the binding affinity for each of the protein ligand complexes may be stored. In such embodiments, the predefined threshold may be viewed as being set to a value that encompasses all protein-ligand complexes in the ligand set 113.

Moving on to box 216, the ligand analysis application 104 stores the selected set of protein-ligand complexes to the data store 106 (FIG. 1) as the result set 119 (FIG. 1). Execution subsequently ends.

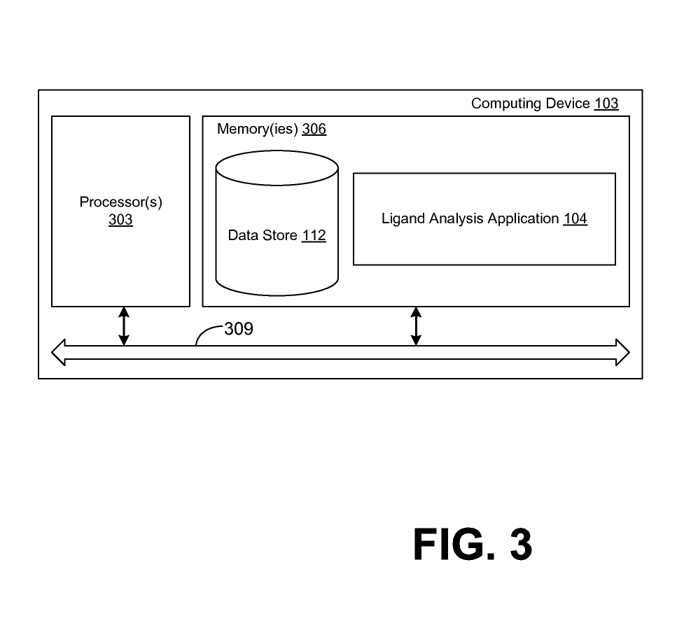

With reference to FIG. 3, shown is a schematic block diagram of the computing device 103 according to an embodiment of the present disclosure. The computing device 103 includes at least one processor circuit, for example, having a processor 303 and a memory 306, both of which are coupled to a local interface 309. To this end, the computing device 103 may comprise, for example, at least one server computer or like device. The local interface 309 may comprise, for example, a data bus with an accompanying address/control bus or other bus structure as can be appreciated.

Stored in the memory 306 are both data and several components that are executable by the processor 303. In particular, stored in the memory 306 and executable by the processor 303 are the ligand analysis application 104, and potentially other applications. Also stored in the memory 306 may be a data store 112 and other data. In addition, an operating system may be stored in the memory 306 and executable by the processor 303.

It is understood that there may be other applications that are stored in the memory 306 and are executable by the processors 303 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 306 and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory 306 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 306 is defined herein as including both volatile and nonvolatile memory and data storage components. Volatile components are those that do not retain data values upon loss of power. Nonvolatile components are those that retain data upon a loss of power. Thus, the memory 306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 303 may represent multiple processors 303 and the memory 306 may represent multiple memories 306 that operate in parallel processing circuits, respectively. In such a case, the local interface 309 may be an appropriate network that facilitates communication between any two of the multiple processors 303, between any processor 303 and any of the memories 306, or between any two of the memories 306, etc. The local interface 309 may comprise additional systems designed to coordinate this communication, including, for example, performing load balancing. The processor 303 may be of electrical or of some other available construction.

Although the ligand analysis application 104 and any other applications herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Any logic or methods disclosed herein, if embodied in software may represent one or more modules, segments, or portions of code that comprise program instructions to implement the specified logical function(s). The program instructions may be embodied in the form of source code that comprises human-readable statements written in a programming language or machine code that comprises numerical instructions recognizable by a suitable execution system such as a processor 303 in a computer system or other system. The machine code may be converted from the source code, etc. If embodied in hardware, each block may represent a circuit or a number of interconnected circuits to implement the specified logical function(s).

Also, any logic or application described herein, including the ligand analysis application 104, that comprises software or code can be embodied in any non-transitory computer-readable medium for use by or in connection with an instruction execution system such as, for example, a processor 303 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the measurement technique and the type of numerical value. In addition, the phrase “about ‘x’ to ‘y’” includes “about ‘x’ to about ‘y’”.

Therefore, the following is claimed:

1. A non-transitory computer-readable medium embodying a program executable in at least one computing device, comprising:
code that selects a set of ligands for analysis of a binding affinity of each ligand in the set of ligands with respect to a protein receptor;
code that applies a scoring model to each ligand to predict the binding affinity for each ligand to the protein receptor; and
code that ranks each ligand according to a predicted binding affinity determined from the application of the scoring model.

2. The non-transitory computer-readable medium of claim 1, wherein the scoring model sums a van der Waals force, a hydrogen bond force, a desolvation force, and a metal chelation force to predict the binding affinity for the ligand to the protein receptor.

3. The non-transitory computer-readable medium of claim 2, wherein the scoring model further:
categorizes each ligand of the set of ligands into one of a plurality of groups of ligands based on a molecular weight and a ratio of carbon atoms in each ligand before summing the van der Waals force, the hydrogen bond force, the desolvation force, and the metal chelation force; and
applies a different scoring parameter to each of the plurality of groups.

4. The non-transitory computer-readable medium of claim 1, wherein the scoring model further calculates a potential of mean force between each ligand in the set of ligands and the protein receptor, wherein the potential of mean force is equated with a Lennard-Jones potential.

5. The non-transitory computer-readable medium of claim 1, wherein the program further comprises:
code that recognizes a starting position for each ligand in the set of ligands with a binding pocket of the protein receptor;
code that performs a three-dimensional movement within the binding pocket for each ligand, wherein the three-dimensional movement comprises at least one of a single bond rotation, a whole molecular rotation, and a translational movement;
code that repeatedly generates a new pose for each ligand from a performance of the three-dimensional movement until the new pose collapses within the binding pocket; and
code that applies the scoring model to the new pose.

6. The non-transitory computer-readable medium of claim 1, wherein the program further comprises code that selects at least one ligand with a predicted binding affinity matching a threshold binding affinity.

7. The non-transitory computer-readable medium of claim 1, wherein the program further comprises code that calibrates the scoring model using a training set of ligands, where each ligand in the training set of ligands comprises a known binding affinity for the protein receptor.

8. A system, comprising:
at least one computing device; and
a ligand analysis application executable in the at least one computing device, the ligand analysis application comprising:
logic that selects a set of ligands for analysis of a binding affinity of each ligand in the set of ligands with respect to a protein receptor;
logic that applies a scoring model to each ligand to predict the binding affinity for each ligand to the protein receptor; and
logic that ranks each ligand according to a predicted binding affinity determined from the application of the scoring model.

9. The system of claim 8, wherein the scoring model sums a van der Waals force, a hydrogen bond force, a desolvation force, and a metal chelation force to predict the binding affinity for the ligand to the protein receptor.

10. The system of claim 10, wherein the scoring model further:
categorizes each ligand of the set of ligands into one of a plurality of groups of ligands based on a molecular weight and a ratio of carbon atoms in each ligand before summing the van der Waals force, the hydrogen bond force, the desolvation force, and the metal chelation force; and
applies a different scoring parameter to each of the plurality of groups.

11. The system of claim 8, wherein the scoring model further calculates a potential of mean force between each ligand in the set of ligands and the protein receptor, wherein the potential of mean force is equated with a Lennard-Jones potential.

12. The system of claim 8, wherein the ligand analysis application further comprises:
logic that recognizes a starting position for each ligand in the set of ligands with a binding pocket of the protein receptor;
logic that performs a three-dimensional movement within the binding pocket for each ligand, wherein the three-dimensional movement comprises at least one of a single bond rotation, a whole molecular rotation, and a translational movement;
logic that repeatedly generates a new pose for each ligand from a performance of the three-dimensional movement until the new pose collapses within the binding pocket; and
logic that applies the scoring model to the new pose.

13. The system of claim 8, wherein the ligand analysis application further comprises logic that selects at least one ligand with a predicted binding affinity matching a threshold binding affinity.

14. The system of claim 8, wherein the ligand analysis application further comprises logic calibrates the scoring model using a training set of ligands, where each ligand in the training set of ligands comprises a known binding affinity for the protein receptor.

15. A method, comprising the steps of:
selecting, via a computing device, a set of ligands for analysis of a binding affinity of each ligand in the set of ligands with respect to a protein receptor;
applying, via the computing device, a scoring model to each ligand to predict the binding affinity for each ligand to the protein receptor; and
ranking, via the computing device, each ligand according to a predicted binding affinity determined from the application of the scoring model.

16. The method of claim 15, wherein the scoring model sums, via the computing device, a van der Waals force, a hydrogen bond force, a desolvation force, and a metal chelation force to predict the binding affinity for the ligand to the protein receptor.

17. The method of claim 16, wherein the scoring model further:
categorizes, via the computing device, each ligand of the set of ligands into one of a plurality of groups of ligands based on a molecular weight and a ratio of carbon atoms in each ligand before summing the van der Waals force, the hydrogen bond force, the desolvation force, and the metal chelation force; and
applies, via the computing device, a different scoring parameter to each of the plurality of groups.

18. The method of claim 15, wherein the scoring model further comprises calculating, via the computing device, a potential of mean force between each ligand in the set of ligands and the protein receptor, wherein the potential of mean force is equated with a Lennard-Jones potential.

19. The method of claim 15, further comprising the steps of:
recognizing, via the computing device, a starting position for each ligand in the set of ligands with a binding pocket of the protein receptor;
performing, via the computing device, a three-dimensional movement within the binding pocket for each ligand, wherein the three-dimensional movement comprises at least one of a single bond rotation, a whole molecular rotation, and a translational movement;
repeatedly generating, via the computing device, a new pose for each ligand from a performance of the three-dimensional movement until the new pose collapses within the binding pocket; and
applying, via the computing device, the scoring model to the new pose.

20. The method of claim 15, further comprising the step of calibrating, via the computing device, the scoring model using a training set of ligands, where each ligand in the training set of ligands comprises a known binding affinity for the protein receptor.
